(19) United States
(12) Patent Application Publication
(10) Pub. No.: US 2019/0171160 A1
(43) Pub. Date: Jun. 6, 2019

(54) SHAPED BODY HAVING A VOLUME HOLOGRAM AND METHOD FOR PRODUCTION THEREOF

(71) Applicant: Covestro Deutschland AG, Leverkusen (DE)

(72) Inventors: Rainer HAGEN, Leverkusen (DE); Thomas FÄCKE, Leverkusen (DE); Enrico ORSELLI, Köln (DE); Ute FLEMM, Solingen (DE); Ulrich GROSSER, Kürten (DE)

(21) Appl. No.: 16/324,746

(22) PCT Filed: Aug. 10, 2017
(86) PCT No.: PCT/EP2017/070296

§ 371 Date: Feb. 11, 2019

(30) Foreign Application Priority Data
Aug. 12, 2016 (EP) 16183919.6

(51) Int. Cl. G03H 1/02; B29C 45/14

(52) U.S. Cl. CPC G03H 1/0272; G03H 1/0248; G03H 1/0252; B29C 45/14336; B29C 45/14688; B29L 2011/00; G03H 2250/37; G03H 2260/12; G03H 2270/14; G03H 2270/31; B29K 2905/00; G03H 2250/10

(57) ABSTRACT

The present invention concerns a method for the production of a moulded body containing at least one volume hologram by means of injection moulding, comprising the following method steps:
provision of a hologram film composite having two sides comprising at least one photopolymer layer with at least one volume hologram, a shear protective layer and a substrate layer, and optionally, further composite film layers,
insertion of the hologram film composite into a metallic injection mould, such that one side of the hologram film composite is at least partially in contact with the injection mould wall,
introduction of a molten thermoplastic polymer for the production of the moulded body, wherein at least the outermost layer of the hologram film composite on the side of the hologram film composite coming into contact with the molten polymer contains essentially the same polymer raw materials as the molten thermoplastic polymer, and extrusion coating of the hologram film composite with the molten thermoplastic polymer, and
solidification of the molten thermoplastic polymer.

The invention also concerns a moulded body produced in this manner and advantageous applications of this moulded body.

The invention concerns a method for the production of a moulded body containing at least one volume hologram by means of injection moulding. The invention further concerns a moulded body produced by injection moulding composed of thermoplastic polymer and containing at least one volume hologram, wherein the volume hologram is embedded in the moulded body and the moulded body is at least partially optically transparent in the effective area of the volume hologram.

Volume holograms are known in the literature and are also referred to as thick holograms or Bragg holograms. According to the definition of a volume hologram, its thickness is much greater than the light wavelength used for the recording of the hologram. There are two types of volume holograms, so-called volume absorption holograms and volume phase holograms. In this application, the holograms are all volume phase holograms.

Examples of recording materials for holograms include metal halide emulsions, halide emulsions, dichromated gelatins and photopolymers. Their functions, chemical composition and applications are described in the literature [“Optical Holography”, by P. Hariharan, Cambridge University Press (1996), ISBN 0 521 43348 7].

Relevant for the present invention are photopolymers. Holograms are stored in the layers of these photopolymers as volume phase gratings.

Holograms are ordinarily present as a film composite comprising an optically clear carrier film (substrate) and a holographic photopolymer film placed thereon.

Injection moulding is an established and economical method for the processing of film composites. It can be used on a film composite with hologram(s) stored in a photopolymer layer, for example in order to place an originally smooth hologram in the mould, stabilize it mechanically, or protect it against external influences such as UV light, moisture, mechanical stress, dirt or attacking chemicals.

In injection moulding, the hologram film composite is ordinarily placed in an injection mould and overmoulded or insert-moulded with a thermoplastic polymer that has been brought to a molten state at elevated temperature.

Examples of known transparent technical-grade thermoplastics include polycarbonate (PC), polymethacrylate (PMMA), polystyrene (PS), amorphous polyamide (PA) and amorphous polyester, polyvinylchloride (PVC), polyethylene terephthalate (PET), PC/PET and polybutylene terephthalate (PBT). Examples of known opaque technical-grade thermoplastics include crystalline polyamide (PA), acrylonitrile-butadiene-styrene (ABS), polyethylene (PE), PC/ABS, polypropylene (PP) and polyether ether ketone (PEEK).

Holographically exposed photopolymers are relatively soft, shear-sensitive materials. The photopolymer layer, including the structure of the volume phase grating included therein, must not change during processing in the course of injection moulding, for example it must not become warped, crumpled, or wavy. As the hologram properties are derived from the geometric orientation and period of the grating structures, a change in the grating structure also means a change in or even destruction of the hologram function.

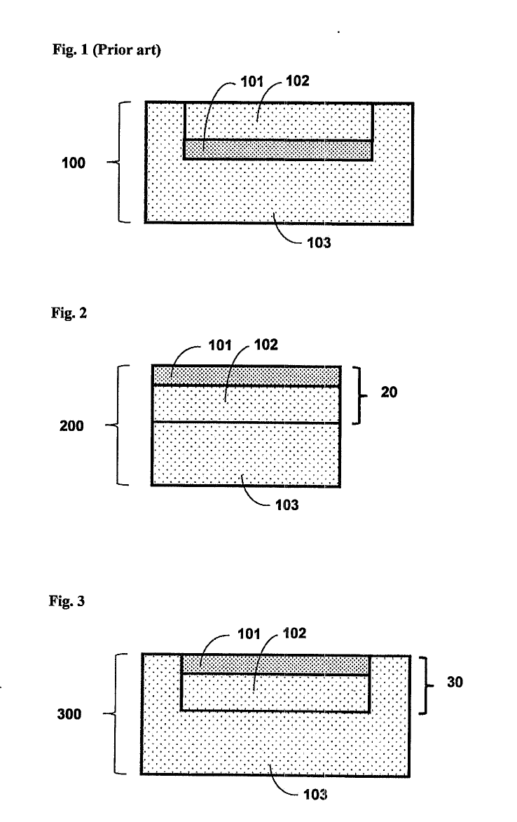

FIG. 1 shows an overmoulded hologram film composite according to the prior art. This comprises a holographic photopolymer 101 that is embedded in the moulded body 100. The carrier film 102 is external and completely covers the photopolymer 101, so that a barrier and protective function is provided. This moulded body 100 is provided by means of an injection moulding method in which the photopolymer and thus also the holographic grating structures present therein are overmoulded, i.e. are in contact with the hot thermoplastic melt. It is known that starting from the sprue, the melt flows into the cavity, thus exerting forces such as shearing forces on the film composite placed in the mould, which can cause damage to the photopolymer layer. This method is therefore disadvantageous.

A current challenge is therefore to maintain the grating structures of the hologram unchanged during processing in injection moulding and thus obtain a moulded body with defined optical and holographic-optical properties. These holographic-optical properties include the Bragg diffraction condition, measurable via the mean reconstruction angle and the central reconstruction wavelength, the colour value, and the intensity of the diffracted light at a given observation position. For example, the extended optical properties include the quality of the surface of the hologram and the transparency of the hologram outside the diffraction condition, measurable via the haze value, small-angle scattering, and absorption.

Examples of injection-moulded holograms in which the photopolyrner is protected from contact with the melt by a film laminate are given in the application JP 2008-170852(A). However, the internal laminate has the drawback of not bonding to the polymer melt in injection moulding. In order to provide an integral bond, additional measures are required, such as the production of an internal laminate with a protrusion or a laterally bevelled multilayer structure. These layer structures with a hologram are insert-moulded and thus bonded to the moulded body. Drawbacks are the increased expenditure for the production of the hologram film composite suitable for injection moulding and the limitations with respect to design and process freedom in injection moulding.

The object of the present invention was to provide a simplified method for the production of a moulded body containing at least one volume hologram by means of injection moulding as well as a dimensionally stable, mechanically robust thermoplastic injection moulded body containing at least one volume hologram, wherein both the optical quality, such as the haze value, small-angle scattering, and absorption of the volume hologram, remain unchanged and the holographic-optical properties, such as the diffraction efficiency and reconstruction wavelength of the volume hologram, remain unchanged within narrow limits.

The object according to the present invention is achieved by a method for the production of a moulded body containing at least one volume hologram by means of injection moulding of the above type, wherein the method is characterized by the following steps:
provision of a hologram film composite having two sides comprising at least one photopolymer layer with at least one volume hologram, a shear protective layer and a substrate layer, and optionally, further composite film layers,
insertion of the hologram film composite into a metallic injection mould, such that one side of the hologram film composite is at least partially in contact with the injection mould wall,
introduction of a molten thermoplastic polymer for the production of the moulded body, wherein at least the outermost layer of the hologram film composite on the side of the hologram film composite coming into contact with the molten polymer contains essentially the same polymer raw materials as the molten polymer, extrusion coating of the hologram film composite with the molten polymer, and
solidification of the molten, thermoplastic polymer.

The hologram film composite prepared according to the invention comprises at least one photopolymer layer with at least one volume hologram, a shear protective layer to which the at least one photopolymer layer adheres, and a substrate layer.

During the injection moulding process, the substrate layer takes on the function of a stable carrier layer for the soft, flexible photopolymer layer. The shear protective layer serves to prevent contact, to the extent possible, between the photopolymer layer and the hot melt flowing into the injection mould. For this purpose, the shear protective film should preferably cover the entire surface of the photopolymer layer. Optionally, further composite layers can be added to the hologram film composite. For example, the substrate layer or the shear protective layer may be composed of film composites. These composites may be produced, for example, by lamination, microlayer coextrusion or wet coating methods. It is also possible to laminate more than one holographic photopolymer layer onto one another, which more particularly is advantageous when a plurality of holographic-optical functions are to be separately produced and then combined with one another. Further possible layers are scratch protective layers, decorative layers, contrast-producing layers or the like.

The substrate layer has a layer thickness of 5 to 500 μm, preferably 10 to 300 μm and particularly preferably 25 to 200 μm. It is further characterized by at least one smooth, glossy surface. Preferably, the substrate layer is configured to be transparent and optically clear, but it can also be at least partially opaque, and more particularly printed. If it is provided that the substrate layer comes into contact with the molten thermoplastic polymer during the injection moulding process, it is preferably at least partially surface structured on its surface facing the melt. More particularly, it is preferred in this case that the substrate layer contains a polymer from the group PC, PMMA, PET, PBT, PA, PS and PC/ABS. Preferably, the molten thermoplastic polymer contains polycarbonate (PC). Moreover, the polymer of the substrate layer may contain additives, more particularly solvents, polymeric mixed substances or design-providing particles, dyes or absorbent pigments. These preferably have a volume percentage of less than 20%, preferably less than 10% and particularly preferably less than 5%.

The photopolymers used according to method of the invention may be composed at least of photoinitiator systems and polymerizable writing monomers. The photopolymers preferably comprise softeners and/or thermoplastic binders and/or crosslinked matrix polymers. The photopolymers are particularly preferably composed of a photoinitiator system, one or a plurality of photomonomers, softeners, and crosslinked matrix polymers. The photopolymer layer itself has a layer thickness of 0.5 to 1000 μm, preferably 1 to 200 μm and particularly preferably 2 to 100 μm.

In the hologram film composite, favourable adhesion is achieved if the shear protective film is in direct contact with the photopolymer layer. As experiments conducted by the applicant have shown, the adhesion between the photopolymer layer and the shear protective film can preferably be characterized in that in a cross-cut test (according to DIN EN ISO 2409 2013 (6.2), with eight-time determination of the parameter and arithmetic averaging), it is assessed to have a reference number lower, i.e. better, than 3.

The thermoplastic polymer, which is initially molten, and after completion of the method according to the invention for the production of a moulded body containing at least one volume hologram, hardened, preferably contains a thermoplastic polymer from the group PC, PMMA, PET, PBT, PA, PS and PC/ABS. Preferably, the molten thermoplastic polymer contains polycarbonate (PC). Moreover, the thermoplastic polymer preferably contains additives, more particularly solvents, polymeric mixed substances or design-providing particles, dyes or absorbent pigments. These are preferably contained in a volume percentage of less than 20%, preferably less than 10% and particularly preferably less than 5%.

In a further embodiment of the invention, the thermoplastic polymer contains reinforcing agents, so that the produced moulded body remains dimensionally stable at high temperatures such as those that may occur for example in automotive applications. Examples of suitable reinforcing agents include glass or carbon fibres or fabric.

According to the invention, at least the outermost layer of the hologram film composite, on the side that comes into contact with the molten thermoplastic polymer, contains essentially the same polymer raw materials as the molten polymer. The term “essentially the same polymer raw materials” or “essentially consistent,” primarily refers to polymers containing more than 10%, and preferably more than 50% of the identical monomeric basic structures. Here, monomeric basic structures also include functional groups such as carbonate —O—CO—O—, ester —O—CO—, ether —O—, amide —NH—CO—and identical monomeric bodies such as terephthalate —O—CO-(para-phenyl)-CO—O—, isophthalate —O—CO-(meta-phenyl)-CO—O—, ethylene glycol —O—CH₂—CH₂—O—, butylene glycol —O—CH₂—CH₂—CH₂—CH₂—O—, styrene —CH₂—CH phenyl-, methacrylate —CH₂—CH(O—CO—CH₃)—, methyl methacrylate —CH₂—CCH₃(O—CO—CH₃)—, butyl acrylate —CH₂—CH(O—CO—CH₂—CH₂—CH₂—CH₃)—, butyl methacrylate —CH₂—CCH₃(O—CO—CH₂—CH₂—CH₂—CH₃)—, bisphenol A-O-phenyl-C(CH₃)₂-phenyl-O, hexamethylene diamine —NH—(CH₂)₆—NH, and dodecane diamine-NH—(CH₂)₁₂—NH. It is particularly preferable if the polymers are composed to more than 90% of identical basic structures and do not deviate from one another by more than 50% in their mean number average molecular weight.

The at least one volume hologram contained in the photopolymer layer in the method according to the invention is characterized by comprising grating structures, so-called volume phase gratings. These grating structures, present in the photopolymer as refractive index modulations, deflect light from a suitable light source by Bragg diffraction, thus producing a predetermined illumination pattern, holographic image, holographic stereogram or the like. The hologram is preferably configured as a holographic optical element (HOE), which belongs to the class of the angle and colour-selective diffractive optical elements. The hologram can be a transmission hologram, a reflection hologram or an edge-lit hologram (i.e. a hologram in which one of the two reconstruction angles runs in the substrate medium).

The method according to the invention allows the person skilled in the art to adjust important injection moulding process parameters such as the melt temperature, the course of pressure, the mould temperature and the cycle time in such a way that he can obtain, for his purposes, the best moulding result in the sense of surface quality and isotropy of the solidified polymer, but also in the sense of working and facilities costs. The person skilled in the art is not restricted with respect to the use of special moulding materials or further tools or substances, such as sheet moulding compounds. The method according to the invention can therefore also be combined or supplemented with known methods, such as in-mould coating (IMC), in-mould decoration (IMD) or film-insert moulding (FIM). The possibilities for process engineering variations are therefore retained.

According to the invention, the hologram film composite is inserted into a metallic injection mould such that one side of the hologram film composite is at least partially in contact with the injection mould wall. Contact within the meaning of this invention means that the hologram film composite lies at one site in planar fashion against the wall of the injection mould or is connected to the injection mould at a selected site. For example, such a site can also be formed by an edge to which the hologram film composite is clamped or glued. The hologram film composite may also comprise a tab that is positioned outside the cavity of the injection mould.

With respect to the individual layers of the hologram film composite, this can mean specifically that according to a first embodiment of the method according to the invention, the substrate layer is inserted facing the metallic injection mould with its side that faces away from the photopolymer layer, such that the substrate layer is at least partially in contact, preferably in planar contact, with the injection mould wall. In this case, the photopolymer layer is located on the side of the substrate layer facing away from the injection mould. Protection of the sensitive photopolyrner layer from the polymer melt is preferably provided in this case by the shear protective layer, which is arranged on the side of the photopolymer layer facing away from the substrate layer and in this case, as the outermost layer of the hologram film composite according to the teaching of the invention, preferably contains essentially the same polymer raw materials as the molten polymer.

According to an advantageous embodiment of the invention, the shear protective layer can be composed for example of a protective lacquer.

According to the invention, because at least the outermost layer of the hologram film composite in the embodiment described above and the shear protective film, on its side in contact with the molten polymer, contain essentially the same polymer raw materials as the molten polymer, the method according to the invention not only prevents the sensitive photopolymer layer from coming into contact with the polymer melt, so that as a result, no effects of shearing forces are exerted on the photopolymer layer. Rather, the mutually adapted material composition of the outermost layer of the hologram film composite and the molten polymer ensure favourable adhesion of the hologram film composite to the solidified melt. If the hologram film composite is positioned in the injection mould such that not only one flat side of the hologram film composite, but at least in some areas, the opposite flat side also comes into contact with the thermoplastic melt during the injection moulding process, it is understandable that this side must also be covered with a layer that is material-adapted with respect to the melt material.

According to an alternative advantageous embodiment of the invention, it is provided that the photopolymer layer is inserted with its free surface facing the metallic injection mould, such that the photopolymer layer is at least partially in preferably planar contact with the injection mould wall. This means that both the substrate layer and the shear protective film are arranged on the side of the photopolymer layer facing away from the metallic injection mould.

In a particular embodiment, the hologram film composite containing the photopolymer layer is preformed prior to insertion by means of a thermoforming process (such as vacuum thermoforming, (high-)pressure thermoforming and various variant embodiments thereof), so that good dimensional accuracy can be imparted with respect to the injection mould.

According to a further advantageous embodiment of the invention, it can be provided that the substrate layer and the shear protective layer are integrally configured. More particularly, the substrate layer integrally configured with the shear protective layer constitutes the outermost layer of the hologram film composite on its side coming into contact with the molten polymer and thus simultaneously assumes the function of the shear protective film. It then essentially contains the same polymer raw materials as the molten polymer, and more particularly, it is a thermoplastic film that is chemically essentially identical to the injection moulded polymer. On overmoulding, the film and the melt bind to each other in a mechanically stable manner, and because of the composition of the outermost layer of the hologram film composite and the molten polymer, in which the materials are adapted to one another, favourable adhesion of the hologram film composite to the solidified melt is ensured.

According to a further particularly advantageous embodiment of the invention, it is provided that the hologram film composite, before insertion of the hologram film composite into the metallic injection mould, is cut such that all layers of the hologram film composite have the same dimensions, with common cut edges that are oriented essentially perpendicularly to the extension of the hologram film composite. Because of the favourable adhesion between the hologram film composite and the surrounding (initially molten) thermoplastic polymer, it is not necessary in the method according to the invention, as for example in the prior art for JP 2008-170852 A, to provide mechanical clamping between the film composite and the surrounding polymer by means of bevelling the edges, staggering the sequence of the layers or similar mechanical measures.

More particularly, in the case of direct contact of the wall of the metallic injection mould with the sensitive photopolymer layer, it is provided according to a further advantageous embodiment of the invention that the wall of the metallic injection mould does not exceed a maximum temperature of 100° C., preferably 90° C., and particularly preferably 80° C.

An advantageous embodiment of the invention provides that during the injection moulding process, the internal mould pressure is a maximum of 1000 bar, preferably a maximum of 800 bar and more particularly a maximum of 700 bar, wherein the cycle time is a maximum of 30 s, preferably a maximum of 25 s and more particularly a maximum of 20 s.

Preferably, the injection mould is made of polished steel. Moreover, the injection mould preferably has at least one essentially flat surface. Preferably, this surface has a roughness of less than 50 μm, preferably less than 20 μm and particularly preferably less than 10 μm. The method is suitable for thin-walled and thick-walled moulded parts.

Moreover, the injection mould is preferably formed in a flat or continuous manner, with “continuous” within the meaning of the present invention indicating that a curvature in the area of the volume hologram exposed in the photopolymer layer has no edges and a curvature also has a radius of greater than 3 cm, and preferably greater than 5 cm, wherein curvature also expressly refers to shapes that are not exclusively spherical, but are also configured with variable curvature.

With respect to preserving the holographic-optical properties of the at least one hologram written into the photopolymer layer, experiments conducted by the applicant indicated that in a moulded body produced according to the method of the invention, the spectral diffraction efficiency of the hologram preferably changes by less than 2% as a result of thermal and mechanical stress during processing in injection moulding with a plane film geometry in the area of the hologram. In the same manner, the spectral half-value width of the hologram changes more particularly by less than 1 nm. In addition, the spectral peak position, i.e. the wavelength at which the hologram reaches its efficiency maximum, is shifted with respect to long or short wavelengths by less than 10 nm, in some cases by less than 5 nm and in the ideal case by less than 2 nm.

In a preferred embodiment, the hologram is oriented parallel to the steel mould, wherein in the case of a curved steel mould, the hologram is naturally located at an equidistant position with respect to the steel mould. In this case, the distance of the hologram from the steel mould is determined by its substrate or one or a plurality of layers. This distance is less than 300 μm, preferably less than 100 μm, and most particularly preferably less than 70 μm.

A further aspect of the present invention concerns a moulded body containing at least one volume hologram produced by a method according to one of claims 1 through 13. What is stated above applies correspondingly to the advantages of this moulded body.

A further aspect of the present invention concerns the use of a moulded body containing at least one volume hologram according to claim 14 as a beam-guiding and/or beam-forming optical component for 3-dimensional imaging or as a security hologram in documents and for product protection and product labelling or as a spectacle lens in corrective glasses and electronic glasses (so-called augmented reality (AR) glasses).

Application examples for holographic-optical elements include holographic, machine-readable data storage devices, transparent display devices in automobiles (such as head up displays), transparent display devices for points of sale and points of interest, transparent display devices for TV and mobile IT applications, light-guiding and light-conducting elements for general and automotive lighting and light-guiding and light-conducting elements for glasses with special holographic-optical integrated functions.

In the following, the invention will be explained in greater detail with reference to a drawing present embodiments. The figures show the following:

FIG. 1 a hologram film composite according to the prior art,

FIG. 2 a moulded body containing at least one volume hologram produced by means of injection moulding in a first embodiment,

FIG. 3 a moulded body containing at least one volume hologram produced by means of injection moulding in a second embodiment,

FIG. 4 a moulded body containing at least one volume hologram by means of injection moulding in a third embodiment,

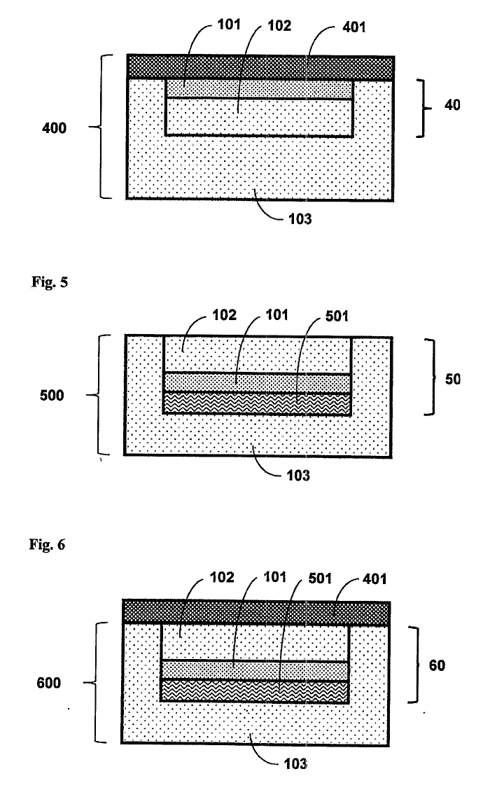

FIG. 5 a moulded body containing at least one volume hologram by means of injection moulding in a fourth embodiment,

FIG. 6 a moulded body containing at least one volume hologram by means of injection moulding in a fifth embodiment,

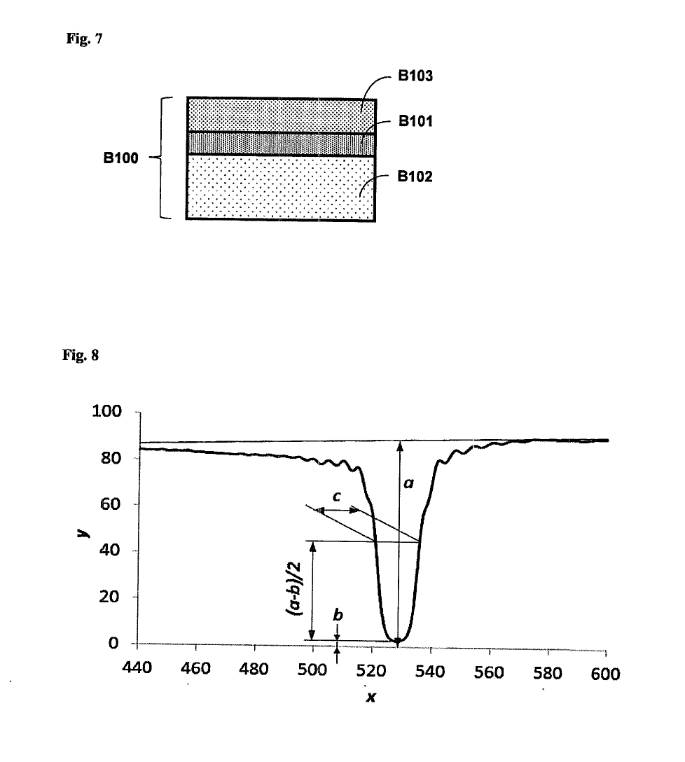

FIG. 7 the basic structure of a holographic film, and

FIG. 8 the transmission spectrum of a reflection hologram contained in a moulded body produced by injection moulding.

FIG. 2 shows a moulded body 200 containing at least one volume hologram produced by means of injection moulding in a first embodiment. More particularly, the moulded body 200 comprises a hologram film composite 20, which in turn comprises a photopolymer layer 101 and a substrate layer 102 lying thereunder. It can be specifically seen that the holographic photopolymer 101, which contains the at least one volume hologram, is open on one side. The substrate layer 102 is arranged on the opposite side. With respect to the injection moulding process carried out using an injection mould (not shown), this means that the hologram film composite 20 comprising the photopolymer layer 101 and a substrate layer 102 were inserted into the metallic injection mould such that the photopolymer layer 101 was oriented with its free surface facing the metallic injection mould, such that the photopolymer layer 101 was at least partially in contact with the injection mould wall (not shown). The substrate layer 102 protects the sensitive photopolymer layer 101 during the injection moulding process from the hot inflowing thermoplastic polymer and the resulting shear forces by functioning as a shear protective film. Accordingly, in the present case, the substrate layer 102 and the shear protective layer are configured as a single piece.

In the present case, moreover, the hologram film composite 20, before insertion in the metallic injection mould, is cut in such a way that all of the layers of the hologram film composite 20 have the same dimensions, with common cut edges that are oriented essentially perpendicularly to the extension of the hologram film composite.

The dimensions of the hologram film composite 20 are selected relative to the injection mould is such a way that by means of the extrusion coating of the hologram film composite 20 with the molten, thermoplastic polymer, only one further layer 103 is built up on the back side of the substrate layer 102. Although the injection mould thus constitutes only a cuboid cavity, a side surface of the cavity is completely covered by the inserted hologram film composite 20, wherein the photopolymer layer 101 is in planar contact with the injection mould wall. Accordingly, during the injection moulding process, the hologram film composite 20 is not insert-moulded, but only overmoulded.

Because of the fact that the outermost layer of the hologram film composite 20, in the present case the substrate layer 102, contains essentially the same polymer raw material as the molten thermoplastic polymer 103 on the side of the hologram film composite 20 coming into contact with the molten polymer 103, a stable compound is produced between the molten thermoplastic polymer and the substrate layer 102.

FIG. 3 shows a moulded body 300 containing at least one volume hologram produced by means of injection moulding in a second embodiment. In contrast to the moulded body 200, the dimensions of the hologram film composite 30 of the moulded body 300 are selected to be smaller than the lateral surface of the cavity of the injection mould used (not shown), which comes into contact with the photopolymer layer 101 before the molten thermoplastic polymer is introduced. Accordingly, this side surface is not completely covered by the hologram film composite 30 during extrusion coating with the molten thermoplastic polymer. This in turn causes the hologram film composite 30 to be “insert-moulded” with the melt, i.e. the edges of the hologram film composite 30 also come into contact with the molten thermoplastic polymer 103. The hologram film composite 30, before insertion into the metallic injection mould, is again cut so that all layers of the hologram film composite 30 have the same dimensions. A stable compound is produced between the molten, thermoplastic polymer and the substrate layer 102, without requiring mechanical clamping of the hologram film composite 30 with the molten thermoplastic polymer 103.

FIG. 4 shows a further modified embodiment of a moulded body 400 containing at least one volume hologram by means of injection moulding. In this embodiment, a covering layer 401 that covers the entire surface of the photopolymer layer 101 and the substrate layer 102 is provided, wherein the covering layer 401 is preferably a protective film with a scratch protecting function. In a further embodiment, the covering layer 401 is an absorbent decorative layer. Moreover, the covering layer 401 may be coloured. For example, the moulded body 400 can be configured such that the decoration provided by the covering layer 401 lies outside the hologram surface(s) of the photopolymer layer 101, wherein the volume hologram is in the form of a reflection hologram that is visible through the decorative layer 401. For example, the covering layer can be applied to the photopolymer layer 101 by means of the in-mould decoration (IMD) method known from the prior art. This means that the covering layer 401 is first positioned in the injection mould (not shown) together with the hologram film composite 40, wherein the dimensions of the covering layer 401 extend beyond the dimensions of the two other layers 101, 102. More particularly, the covering layer 401 can be dimensioned such that it completely fills a flat base area in the injection mould. The layered composite with the hologram film composite 40 and covering layer 401 is then insert-moulded with the molten thermoplastic polymer, resulting in the geometry of the moulded body 400 shown. Moreover, the covering layer 401 can be subsequently applied to the moulded body 400 by lamination or gluing.

FIG. 5 shows a further moulded body 500 containing at least one volume hologram produced by injection moulding in a fourth embodiment. As can be seen, the photopolymer layer 101 having at least one volume hologram is now arranged internally. This means that the substrate layer 102 of the hologram film composite 50 is positioned in the metallic injection mould with its side facing away from the photopolymer layer 101 facing the metallic injection mould (not shown) such that the substrate layer 102 is at least partially in contact with the injection mould wall. This also means that the during introduction of the molten thermoplastic monomer, the photopolymer layer 101 is no longer protected by the substrate layer 102 from the effects of the molten thermoplastic polymer. Accordingly, a shear protective film 501 is provided that completely covers the side of the photopolymer layer 101 facing away from the substrate layer 102 and thus provides effective shear protection.

In the embodiment of the moulded body according to FIG. 6, the particular characteristics of the embodiments of FIGS. 4 and 5 are combined, as it were. The moulded body of FIG. 6 thus has a covering layer completely covering the moulded body, more particularly with a decorative or scratch protection function, while the hologram film composite 60 in turn comprises a photopolymer layer 101, a substrate layer 102 and a separate shear protective layer 501. Specifically, the photopolymer layer 101 is in turn arranged in the interior and is protected by the shear protective layer 501 from the effects of the shear forces of the molten thermoplastic polymer.

FIG. 7 shows as an example of the basic structure of a holographic film B100, for example Bayfol HX® from Covestro Deutschland AG. In a preferred embodiment, this holographic Film B100 comprises an approx. 125 μm thick transparent substrate film 102 of polycarbonate on which an approx. 16 μm thick photopolymer film 101 is arranged. This is covered by an approx. 40 μm thick laminating film, which can easily be removed for further processing of the holographic Film B100.

Finally, FIG. 8 shows the transmission spectrum of a reflection hologram contained in a moulded body produced by means of injection moulding and exposed in a photopolymer layer of the type Bayfol® HX (manufacturer: Covestro Deutschland AG). The x value of the diagram is equivalent to the measurement wavelength in nm; the y value is equivalent to the transmission in [%]; value a entered in the diagram is equivalent to the transmission in [%] of the sample without a volume hologram at the wavelength at which the transmission spectrum of the volume hologram reaches its minimum; b is equivalent to the transmission in [%] at the wavelength at which the transmission spectrum of the volume hologram reaches its minimum; c is equivalent to the entire half width of the transmission minimum of the volume hologram [nm].

### EXAMPLES

### Example 1: Production of a Sample for Hologram Exposure

A photopolymer-based holographic recording film from Covesiro Deutschland AG (formerly Bayer MaterialScience AG) of the type Bayfol® HX (B100) is used, see FIG. 6. It is a 16 μm thick light-sensitive photopolymer film (B101) that adheres to a transparent 125 μm polycarbonate carrier film (B102) and is lined with a detachable polyethylene film (B103). A piece of this film measuring approx. 60×30 mm is cut out in the dark laboratory. The lining is then removed, and the free side of the photopolymer is laminated blister-free without residue onto a 1 mm thick glass carrier from SCHOTT by means of a hand roller equipped with a high-quality rubberized pressing roll. The photopolymer is now embedded between the polycarbonate carrier (B102) and the glass carrier. This sample is packed in a light-proof aluminium bag and is thus ready for a subsequent hologram exposure.

### Example 2: Recording of a Hologram

For the exposure (“recording”) of a hologram, a diode-pumped solid-state laser from Coherent is used, with a wavelength □=532 nm and an output power Pₘₐₓ=50 mW. This is integrated into a vibration-damped exposure structure.

The sample produced according to example 1 (B100) is clamped into a sample holder that is tilted by 13° relative to the collimated laser beam. The polycarbonate substrate is located externally on the side on which light is incident. The laser is widened to a diameter of approx. 25 mm and homogenized. The laser is switched on for 2 s, striking the centre of the sample and also the centre of the approx. 15×15 mm mirrored surface of the sample holder. The back reflection of the mirror and the incident beam interfere in the photopolymer and generate a sinusoidal intensity grating during the exposure time that is reproduced in the photopolymer material as a phase grating. The phase grating represents the hologram. After laser exposure, it remains in the photopolymer film as a stable grating structure.

After the end of the holographic exposure, the sample is photobleached and photocured by means of UV/VIS light. A mercury arc lamp from Dr. Mlle AG of the type MH-Strahler UV-400 H is used. Exposure is carried out for 4 min with an average intensity at the location of the sample of approx. 40 mW/cm².

### Sample 3: Reconstruction of the Hologram

Reconstruction of the hologram produced according to example 2 is carried out by means of a method established in the industry according to ISO 17901, “Optics and Photonics Holography”, Part 1 and Part 2, that makes it possible to determine spectral diffraction efficiency in transmission (cf. FIG. 8).

In this case, spectral diffraction efficiency □□ is defined as the fractional ratio of the decrease in the zeroth diffraction order in the holographic film [%] to the transmission of the film without hologram [%], wherein the decrease in the zeroth diffraction order in transmission correlates with the strength of the reconstructed wave, i.e. the wave diffracted on the grating.

In this case, the mirror or reflection is read using a reconstruction light source. By means of Bragg diffraction, the hologram produces a signal wave in the reflection direction. A portion of the reconstruction light wave, the so-called zeroth order, is detected in transmission.

In the practical experiment, a fibre spectrometer from Ocean Optics with a DH-mini light source, optical light guides, a sample holder with a sample plate and a USB2000+ detector is used. The detector is based on a rotating grating element and a CCD sensor array. This functions like a monochromator, with the advantage that the spectrum is measured in situ.

The measuring method comprises the following steps:
a) switching on of the light source
b) placement of the sample in the structure
c) adjustment of the collimating lens so that the light beam corresponds to a well-collimated beam, i.e. as flat a wave as possible
d) positioning of the sample so that light beam falls in the hologram
e) recording of the spectrum in the visible wavelength range in transmission
f) evaluation of the spectrum by determining the values a, b and c according to FIG. 8.

It is observed that the hologram causes a clear break (peak) in the green spectral range of the transmission spectrum, cf. the spectrum in FIG. 8. The spectral width is experimentally determined at c=16 nm. The minimum of the spectrum is reached at the so-called peak wavelength, which is determined at 529 nm. The mathematically determined spectral diffraction efficiency □=(a−b)/a is rounded off to 96%.

### Example 4: Integration of Hologram Samples by Means of Polycarbonate Injection Moulding

a) Structure of HX/PC/Melt

In example 4a, a holographic sample of the type Bayfol® HX (manufacturer: Covestro Deutschland AG) is inserted into an injection moulded body in an injection mould. The sample is equivalent to a film measuring approx. 2×2 cm² with a 2-layer structure composed of a 16 μm thick photopolymer film (HX) containing a green test hologram of the Denisjuk mirror hologram type and a transparent 125 μm thick polycarbonate carrier film (PC). The adhesion between HX and PC was evaluated by means of the cross-cut test (DIN EN ISO 2409 2013 (6.2)) with a reference number of 0. The sample is positioned such that the HX side is aligned in the direction of the steel wall of the injection mould, while the PC side is aligned in the direction of the cavity. The injection mould is closed, and the sample is overmoulded with a hot polycarbonate melt of the type Makrolon 2647 (manufacturer: Covestro Deutschland AG) at approx. 270° C. and 800 bar. After 30 seconds, the sample is finished and the injection mould is opened.

This injection moulded body shows favourable stability, as can be seen by the good adhesive bond between the sample and the solidified melt.

The hologram is then characterized by spectrometry. It shows an unchanged high spectral diffraction efficiency. The peak wavelength has shifted by only 4 nm.

b) Structure of HX/TAC/Melt (not an Example According to the Invention)

In example 4b, a further holographic sample of a Bayfol® HX photopolymer (manufacturer: Covestro Deutschland AG) is placed in an injection moulded body. The sample 4b differs from sample 4a in the carrier film, which here is composed of 50 μm cellulose triacetate (TAC). The sample is positioned and processed according to example 4a.

It is to be observed that TAC and the polycarbonate body have not formed an integral whole. The overmoulded HX and its TAC film can be completely peeled off the polycarbonate body without using any strength.

c) Structure of PC/HX/TAC/Melt (not According to the Invention)

In example 4c, a further holographic sample of a Bayfol® HX photopolymer (manufacturer: Covestro Deutschland AG) is placed in an injection moulded body. In contrast to 4a, the sample is aligned with the PC carrier film in the direction of the steel wall, while the photopolymer is laminated with a cellulose triacetate shear protective film (TAC) and the film is aligned in the direction of the cavity. The adhesion between the HX and TAC was evaluated by means of the cross-cut test (DIN EN ISO 2409 2013 (6.2)) with a reference number of 5. The sample is positioned and processed according to example 4a.

It is to be observed that the photopolymer and its PC carrier film can be completely peeled off the polycarbonate body without using any strength.

e) Structure of PC/HX/Melt—Comparative Example

In example 4e, a holographic sample is placed in an injection moulded body analogously to example 4a. In contrast to 4a, the sample is aligned with the PC side facing the steel wall and the HX side facing the cavity, i.e. without shear protective film. The sample was cut to dimensions approx. 2 cm×2 cm less than the cavity so as to allow flow around the edges and binding to the melt. The injection mould is closed, and the sample is overmoulded with a hot polycarbonate melt of the type Makrolon 2647 (manufacturer: Covestro Deutschland AG) at approx. 260° C. and 650 bar. After 30 seconds, the sample is finished and the injection mould is opened.

This injection moulded body shows destruction over a large area in the form of a wave pattern in the photopolymer film; the hologram is no longer visible at these sites.

f) Structure of Hardcoat/HX/PC/Melt—Example According to the Invention

In example 4f, a 3 layer holographic [sample] is placed in an injection moulded body. The adhesion between the photopolymer film and the polycarbonate carrier film was evaluated by means of the cross-cut test (DIN EN ISO 2409 2013 (6.2)) with a reference number of 0. The sample is positioned in this case such that the hardcoat side is aligned in the direction of the steel wall of the injection mould, while the PC side is aligned in the direction of the cavity. The injection mould is closed, and the sample is overmoulded with a hot polycarbonate melt of the type Makrolon 2647 (manufacturer: Covestro Deutschland AG) at approx. 300° C. and 800 bar overmoulded. After 30 seconds, the sample is finished and the injection mould is opened.

This injection moulded body shows favourable stability, as can be seen by the favourable adhesive bond between the sample and the solidified melt.

The hologram is then spectrometrically characterized. It shows unchanged high spectral diffraction efficiency. The peak wavelength has now shifted by 1 nm.

1.-15. (canceled)

16. A method for the production of a moulded body containing at least one volume hologram by means of injection moulding, comprising the following method steps:
provision of a hologram film composite having two sides comprising at least one photopolymer layer with at least one volume hologram, a shear protective layer and a substrate layer, and optionally, further composite film layers,
insertion of the hologram film composite into a metallic injection mould, such that one side of the hologram film composite is at least partially in contact with the injection mould wall,
introduction of a molten thermoplastic polymer for the production of the moulded body, wherein at least the outermost layer of the hologram film composite on the side of the hologram film composite coming into contact with the molten polymer contains essentially the same polymer raw materials as the molten thermoplastic polymer, extrusion coating of the hologram film composite with the molten thermoplastic polymer, and
solidification of the molten thermoplastic polymer.

17. The method according to claim 16, wherein the hologram film composite is inserted into the metallic injection mould such that the substrate layer is inserted facing the metallic injection mould with its side that faces away from the photopolymer layer, such that the substrate layer is at least partially in contact with the injection mould wall.

18. The method according to claim 16, wherein the shear protective film is formed by a protective lacquer.

19. The method according to claim 16, wherein the hologram film composite is inserted into the metallic injection mould such that the photopolymer layer is inserted with its free surface facing the metallic injection mould, such that the photopolymer layer is at least partially in contact with the injection mould wall.

20. The method according to claim 19, wherein the substrate layer and the shear protective layer are integrally configured.

21. The method according to claim 16, wherein the substrate layer contains a polymer from the group PC, PMMA, PET, PBT, PA, PS and PC/ABS.

22. The method according to claim 16, wherein the thermoplastic polymer contains a polymer from the group PC, PMMA, PET, PBT, PA, PS and PC/ABS.

23. The method according to claim 16, wherein the thermoplastic polymer contains additives, more particularly solvents, polymeric mixed substances or design-providing particles, dyes or absorbent pigments.

24. The method according to claim 23, wherein the additives contained in the thermoplastic polymer have a volume percentage of less than 20%, preferably less than 10% and particularly preferably less than 5%.

25. The method according to claim 16, wherein the thermoplastic polymer contains reinforcing agents, more particularly glass or carbon fibres or fabric.

26. The method according to claim 16, wherein the hologram film composite, before insertion of said hologram film composite into the metallic injection mould, is cut such that all layers of the hologram film composite have the same dimensions, with common cut edges that are oriented essentially perpendicularly to the extension of the hologram film composite.

27. The method according to claim 16, wherein the wall of the metallic injection mould does not exceed a maximum temperature of 100° C., preferably 90° C. and particularly preferably 80° C.

28. The method according to claim 16, wherein the internal mould pressure is a maximum of 1000 bar, preferably a maximum of 800 bar and more particularly a maximum of 700 bar, wherein the cycle time is a maximum of 30 s, preferably a maximum of 25 s and more particularly a maximum of 20 s.

29. A moulded body containing at least one volume hologram produced by the method according to claim 16.

30. A method comprising utilizing the moulded body containing at least one volume hologram according to claim 29 as a beam-guiding and/or beam-forming optical component for 3-dimensional imaging or as a security hologram in documents and for product protection and product labelling.
